(19) United States
(12) Patent Application Publication
(10) Pub. No.: US 2025/0175328 A1
(43) Pub. Date: May 29, 2025

(54) METHOD AND APPARATUS FOR STORING/RECOVERING A PLURALITY OF SECRET SHARES

(71) Applicant: PQShield Ltd, Oxford (GB)

(72) Inventor: Markku-Juhani Olavi SAARINEN, Oxford (GB)

(21) Appl. No.: 19/039,721

(22) Filed: Jan. 28, 2025

Related U.S. Application Data
(63) Continuation of application No. PCT/EP2023/071208, filed on Jul. 31, 2023.

(30) Foreign Application Priority Data
Jul. 29, 2022 (GB) 2211124.9

(51) Int. Cl. H04L 9/08

(52) U.S. Cl. CPC H04L 9/085; H04L 9/0869; H04L 9/0894

(57) ABSTRACT

There is disclosed a computer-implemented method and apparatus for storing data corresponding to secret data represented by a plurality of shares, each of the plurality of shares having a first number of bits. A plurality of random keys are generated, each random key having a second number of bits that is fewer than the first number of bits, wherein the plurality of random keys is one fewer than the plurality of shares. For each random key, the generated random key is used as a seed value for a deterministic function that outputs corresponding intermediate data having the first number of bits. A plurality of modulo addition operations are performed to generate working data having the first number of bits and corresponding to modulo addition of the values of the shares and either a modulo addition or an inverse modulo addition of the values of the intermediate data corresponding to each of the random keys. The working data and the plurality of random keys are then stored. In this way, data corresponding to the secret data is stored in a compressed format in comparison to storing the plurality of shares representing the secret data.

### CROSS-REFERENCE TO RELATED APPLICATIONS

This application is a continuation under 35 U.S.C. § 120 of International Application No. PCT/EP2023/071208, filed Jul. 31, 2023 which claims priority to GB Application No. 2211124.9, filed Jul. 29, 2022, under 35 U.S.C. § 119 (a). Each of the above-referenced patent applications is incorporated by reference in its entirety.

### BACKGROUND OF THE INVENTION

### Field of the Invention

This disclosure relates to the storage of secret data such as cryptographic keys. The disclosure has relevance to a post-quantum cryptographic system implemented in a secure processing environment and utilizing masking as a countermeasure to side-channel attacks.

### Description of the Related Technology

Cryptographic processing operations involve the use of cryptographic keys. In a symmetric encryption system in which the same key is used to encrypt and decrypt a message, there is a need to protect that key from exposure to malicious parties. Similarly, for an asymmetric encryption system utilizing a private key and a public key, there is a need to protect the private key from exposure to malicious parties. To protect the security of cryptographic keys, it is known to perform cryptographic processing operations in a secure processing environment having secure memory and a secure crypto-processor. An example of such a secure processing environment is a hardware security module.

Processing performed in secure processing environments may be vulnerable to side-channel attacks in which an adversary learns side-channel information about the physical execution of an algorithm. The side-channel information may be derived from many sources such as running time, electromagnetic emissions, energy consumption and acoustic emissions. One countermeasure that has been proposed against side-channel attacks is masking, which relies upon techniques in the fields of secret sharing and multi-party computation (MPC). As an example, given a sensitive value x ∈ [symbol] _{q}, masking x consists of representing x as a tuple (x1, . . . , xd) ∈ [symbol] _{q}^{d}, where d is the number of shares (also referred to as the sharing order) and in the context of masking d−1 is often called the masking order, such that (i) Σᵢ₌₁^{d}xᵢ=x mod q and (ii) any subset of t<d distinct xi's looks uniformly random. This tuple may be represented by the notation [symbol] x [symbol] d or [symbol] x [symbol] when d is clear in context. The rationale of masking is that an attacker with the ability of learning the value of t<d variables xi will learn nothing about x.

Cryptographic processing operations can be performed in the secure processing environment using the shares of the cryptographic key in place of the cryptographic key itself. This disclosure addresses techniques to store the shares of the cryptographic key, or other secret data, in a secure manner, either within the secure processing environment or outside of the secure processing environment. An issue with storing a cryptographic key represented as a plurality of shares is that the plurality of shares require additional storage in comparison with the cryptographic key itself. This is a particular problem if it is desired to store the plurality of shares in the secure processing environment because the amount of secure memory in a secure processing environment is usually limited.

### SUMMARY

According to an aspect of the invention, there is provided a computer-implemented method of storing secret data that is represented by a plurality of shares, with each of the plurality of shares having a first number of bits. The method involves generating a plurality of random keys, each random key having a second number of bits that is fewer than the first number of bits, with the number of random keys being one fewer than the number of shares. Each random key is used as a seed value for a deterministic function that outputs corresponding intermediate data having the first number of bits. A plurality of modulo addition operations involving the plurality of shares and the intermediate data associated with each random key to generate working data having the first number of bits and a value corresponding to a modular addition of the values of the shares together with an inverse modular addition of the values of the intermediate data for each of the random keys. The working data is then stored together with the plurality of random keys. As the random keys have fewer bits than the shares, the memory requirement is reduced in comparison with the memory requirement for storing a plurality of shares.

According to another aspect of the invention, there is provided a computer-implemented method of recovering a plurality of shares corresponding to secret data from stored working data and one or more random keys, wherein each of the plurality of secret shares having a first number of bits and each of the plurality of random keys having a second plurality of bits that is fewer than the first number of bits and wherein the number of the one or more random keys is one fewer than the number of the plurality of secret shares. The method comprises determining, for the or each random key of the one or more random keys, intermediate data by using the random key as a seed value for a deterministic function that outputs corresponding intermediate data having the first number of bits. The plurality of secret shares are then determined such that the modulo addition of the plurality of secret shares corresponds to the modulo addition of the working data and the intermediate data corresponding to each of the one or more random keys.

### BRIEF DESCRIPTION OF THE DRAWINGS

Examples of the invention will now be described, by way of example only, with reference to the accompanying drawings, in which:

FIG. 1 is a schematic illustration showing the main components of a cryptographic system according to an example;

FIG. 2 is a flow diagram schematically showing the operations performed to pack a plurality of secret shares corresponding to a cryptographic key into a compressed format for storage;

FIG. 3 is a flow diagram schematically showing the operations performed to unpack the data stored in compressed format to recover a plurality of secret shares corresponding to a cryptographic key; and

FIG. 4 is a schematic illustration showing an example of masking being applied to secret data.

### DETAILED DESCRIPTION

### Introduction

Certain examples described herein relate to a cryptographic system implemented within a secure processing environment that forms part of a communicatively-coupled computing system and securely performs cryptographic operations required by that computing system. For example, the cryptographic system may be provided as a system-on-chip device for inclusion into a larger computing circuit board and/or integrated circuit. The cryptographic system may be implemented in silicon, i.e. as an integrated circuit design that is fabricated alone (e.g., as an Application Specific Integrated Circuit—ASIC) or together with a larger computing system circuit, and/or as a Field Programmable Gate Array (FPGA), e.g. in the form of a specific configuration of the FPGA that is programmed in a suitable hardware description language. In an example, the secure processing environment of the cryptographic module is formed by a hardware security module that provides a trusted processing environment and secure memory. The hardware security module may be tamper-proof, for example by using “potted” hardware, and/or tamper-evident such that attempts to physically access components within the hardware security module are prevented and/or detected.

The cryptographic system may be used as a “post-quantum” cryptographic module or co-processor, allowing one or more processors of the communicatively-coupled computing system to off-load complex “post-quantum” cryptographic operations for quick, secure computation. For example, the cryptographic system may be configured to implement key establishment and digital signature functions on behalf of the computing system. The cryptographic system has a security boundary such that other devices and integrated circuits of the computing system, including the computing system itself, do not have access to secret data that is manipulated within the cryptographic system. The cryptographic system may be configured to autonomously execute post-quantum cryptographic operations as part of a larger hardware system, such as a larger ASIC or FPGA design.

The term “post-quantum” is used herein to describe cryptographic operations and functions that provide protection against attack by a quantum computer. It is a well-known term within the field of cryptography. For example, many popular public-key algorithms are not post-quantum secure because they can be efficiently broken using a sufficiently strong quantum computer. These “quantum insecure” cryptographic algorithms include those based on the integer factorisation problem, the discrete logarithm problem or the elliptic-curve discrete logarithm problem; these may all be easily solved on a sufficiently powerful quantum computer using Shor's algorithm. Operations and functions that have been demonstrated to be post-quantum secure include those based on one or more of: lattice-based cryptography; multivariate cryptography; hash-based cryptography; code-based cryptography; and supersingular elliptic curve isogeny cryptography.

The cryptographic system of the examples is suitable for use in a wide variety of computing systems, from Internet servers to embedded devices. In one implementation, the cryptographic system may be provided as part of a cryptographic system-on-chip (SoC) that may allow for many low-cost embedded devices to implement “post-quantum” cryptography and provide “post-quantum” secure systems. For example, the functions implemented by the cryptographic math unit may allow code or lattice-based cryptographic operations to be rapidly performed, e.g. by off-loading many common low-level binary logic functions such as integer addition, subtraction and/or multiplication. The cryptographic system may be configured or pre-programmed with a set of available functions that may be updatable over time. The cryptographic system may rapidly compute certain functions by avoiding the need to load and interpret distinct instructions as required by a processor of the coupled computing system. The cryptographic system may be considered as a specialised computing device (i.e., a computer) that is designed for integration with larger general-purpose computing devices (e.g., for use as a computer within a computer).

### Example Cryptographic System

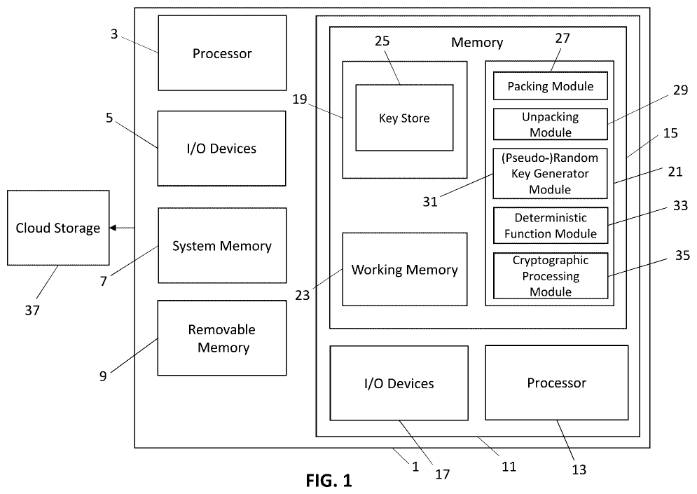

FIG. 1 shows a computing system 1 according to an example. The computer system 1 includes at least one processor 3, input/output devices 5, main system memory 7 and removable memory 9, such as a hard disk device and/or the like. In addition, the computing system 1 includes a cryptographic system 11 that provides a secure processing environment in which cryptographic processing operations are performed. In this example, the cryptographic system 11 is embodied within a hardware security module.

The cryptographic system 11 includes a processor 13, secure memory 15 and input/output devices 17 which enable communication with the remainder of the computer system 1. The secure memory 15 includes data memory 19, program memory 21 and working memory 23. The data memory 19 includes a key store 25 for storing data corresponding to one or more masked cryptographic keys in a compressed format. The program memory 21 stores a packing module 27, an unpacking module 29, a (pseudo-)random key generator module 31, a deterministic function module 33 and a cryptographic processing module 35.

The processor 13 may comprise a Reduced Instruction Set Computer (RISC) processor such as a RISC-V central processing unit (CPU). The processor 13 may comprise a 32- or 64-bit microprocessor (e.g., such as an RV32-I/E-/M/C Pluto core). The processor 13 may comprise one or more processing cores.

In this example the computer system 1 also has access to cloud storage 37 via network communications, for example via the Internet.

The cryptographic processing module 35 of the cryptographic system 11 performs cryptographic processing operations using cryptographic keys. The cryptographic processing operations include: key establishment functions including one or more of encryption and decryption; digital signature functions including one or more of digital signature generation and digital signature verification; and stateful hash-based signatures. In this example, the cryptographic system 11 is optimised for lattice-and code-based cryptography (amongst other post-quantum approaches), as well as “big integer” arithmetic (e.g., arithmetic with large integer values as defined by n-bits where n may be for example 32 or 64).

The security of the cryptographic system 11 is increased using masked computation, in which secret data (such as the cryptographic keys) processed by the computer system 1 is represented within the cryptographic system 11 by a plurality of secret shares such that all secret shares are required in order to derive information about the secret data. Masked computation provides protection against side-channel attacks, which seek to determine bit patterns of data being manipulated by the cryptographic system 11 based on, for example, leakage of secret information via electromagnetic emissions, fluctuations in power use, operation timing, or other unintended side channels, by not manipulating the secret data itself, but rather the shares of the secret data. The number of secret shares may be configurable and set by a parameter of the cryptographic system 11 (e.g., there may be d secret shares where d is an integer value). Typical values of the number d of secret shares are two or three, but other numbers of shares are possible.

The cryptographic system 11 may perform cryptographic operations using many different cryptographic keys, and particularly for asymmetric cryptographic operations the number of bits in each cryptographic key may be large. The amount of non-volatile memory in the secure memory 15 may not be sufficient to store multiple cryptographic keys in uncompressed format, and this problem is exacerbated when the cryptographic keys are represented by multiple shares. The packing module 27 enables a plurality of shares corresponding to a cryptographic key to be stored in compressed format, while the unpacking module 29 enables a plurality of shares corresponding to the cryptographic key to be recovered from the stored compressed data. The recovered plurality of shares need not be the same as the plurality of shares prior to compressed storage, as the unpacking module 29 can automatically perform a refresh operation. Such a refresh operation improves the protection against side-channel attacks. The (pseudo-) random key generator module 31 and the deterministic function module 33 are used during the execution of the packing module 27 and the unpacking module 29, as will now be described in detail.

### Packing Module

The packing module 27 processes a plurality of secret shares corresponding to a cryptographic key to generate compressed data that can be stored in the key store 25 of the cryptographic system 11, or alternatively exported to the main system memory 7 or removable memory 9 of the computer system 1 or to the cloud storage 37. In this example, there are d secret shares, where d is any integer number greater than 1, each having n bits where n is generally in excess of one thousand. In this example, the cryptographic key and the secret shares corresponding to the cryptographic key are modulo q numbers, where q may be for example 2, a composite number such as 256 allowing addition/subtraction of bytes, or a prime number such as 3, 9, 257, 3329, 7681, 12289, 65537 or 8380417.

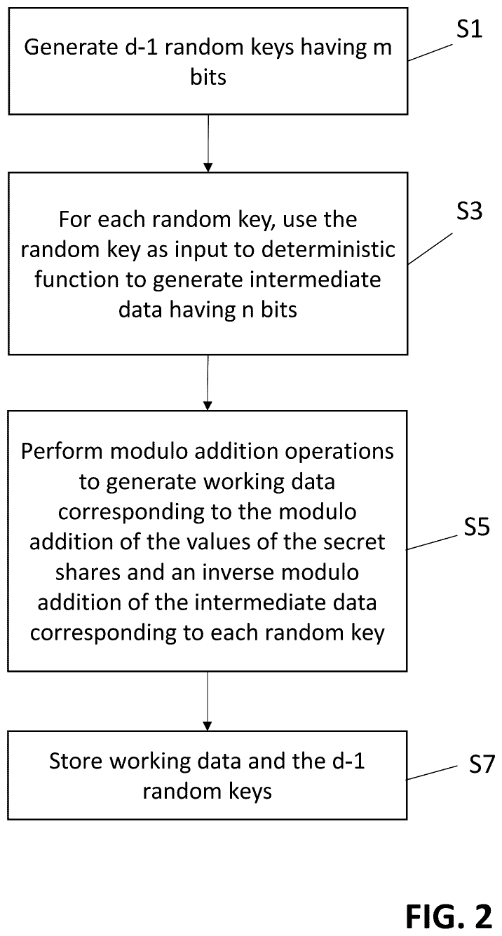

FIG. 2 is a flow chart showing the main operations performed by the packing module 27. As shown, in this example the packing module uses the (pseudo-)random key generator module 31 to generate, at S1, d−1 random keys. Each of the d−1 random keys has m bits, where m is less than n but large enough to be cryptographically secure (e.g. 128 or 256 bits).

The packing module 27 then inputs each of the d−1 random keys as a seed value K for the deterministic function module 37. For each input seed value K, the deterministic function module 37 outputs intermediate data having n bits in accordance with a deterministic function z=f(K) that takes in the seed value K and produces modulo q intermediate data. The deterministic function f(K) may be based on a cryptographic hash function, an extendable output function such SHAKE128 or SHAKE256, or may be based on a cryptographic block cipher such as AES keyed with K and operating in counter mode, or a stream cipher. The deterministic function f(K) may contain a rejection sampler or a similar mechanism to ensure that the output intermediate data is in the modulo q distribution. The deterministic function f(K) may or may not be masked.

Returning to FIG. 2, the packing module 27 then performs, at S5, a sequence of modulo addition operations on the secret shares and the intermediate data corresponding to the random keys in order to generate working data corresponding to the modulo addition of the values of the secret shares and the inverse modulo addition of the intermediate data. There are many different ways in which the sequence of modulo addition operations could be performed to achieve this result. In this example, the sequence of modulo addition operations avoids starting by the modulo addition of the values of all the secret shares as this would result in the cryptographic key being generated, and would therefore open a vulnerability to direct discovery of the cryptographic key by side channel attacks.

Finally, the packing module 27 stores, at S7, the working data and the d−1 random keys as a representation of the cryptographic key. It will be appreciated that the working data has n bits and each random key has m<n bits, and therefore the number of bits required is less than for storing the d secret shares. For example, if d=8, m=256 bits and n=8192 bits, storage is reduced from 65536 bits to 9984 bits.

In the instance that d=2, an example of the processing operations of FIG. 2 can be represented by a function PackRefresh(S[1],S[2]) as follows:

Step 1. K=new random key

### Step 2. Z=f(K)

Step 3. t=S[1]−z (mod q)

### Step 4. S′=S[2]+t (mod q)

Step 5. return (S′, K)

Step 1 involves the generation of a new random key. Step 2 uses the deterministic function f(K) to generate intermediate data z. Step 3 performs an inverse modular addition to subtract the intermediate data z from the first secret share S[1] to generate temporary data t. Step 4 performs a modular addition operation of the second secret share S[2] and the temporary data t to generate the working data S′. Step 5 returns the working data S′ and the random key K. It will be appreciated that the working data S′ corresponds to the modulo addition of the first share S[1] and the second secret share S[2] and the inverse modulo addition of the intermediate data z.

For the more general case in which there is an arbitrary number d secret shares, an example of the processing operations of FIG. 2 can be represented by a function PackRefresh-Long(S[1], S[2], . . . . S[d]) as follows:

### Step 1. S′=S[1]

Step 2.1. for i=1, 2, . . . d−1 do:

### Step 2.2. (S′, K[i])=PackRefresh(S′, S[i+1])

### Step 2.3. end do

Step 3 return (S′, K[1], K[2] . . . . K[d−1])

In this example, S′ represents a working variable which at the end of the routine forms the working data. In step 1, the working variable S′ is assigned the value of the first share. Steps 2.1-2.3 iterate for the remaining shares S[2] to S[d] the PackRefresh algorithm described above with the working variable S′ and the share S[i+1] as inputs. With each iteration, the value of the secret share S[i] is added to the working variable and the intermediate data z[i] corresponding to the random key K[i] is subtracted from the random data. Step 3 then returns the working data S′ and the d−1 random keys.

### Unpacking Module

It will be appreciated that the stored working data is equivalent to the value of the cryptographic key [[S]] with intermediate data z corresponding to each random key K subtracted. The unpacking module 29 generates a set of d secret shares corresponding to the cryptographic key. As will become apparent hereafter, the set of d secret shares generated by the unpacking module 29 will generally not be identical to the set of d secret shares used to generate the working data, and accordingly the unpacking module 29 may refresh the set of secret shares in comparison to the secret shares used to generate the stored working data.

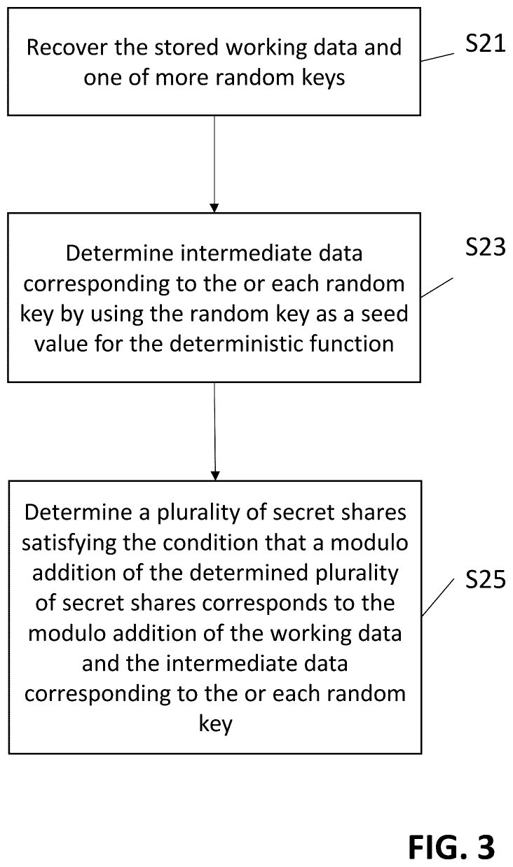

FIG. 3 is a flow chart showing the main operations performed by the unpacking module 29. The unpacking module 29 recovers, at S21, the stored working data and one or more random keys from the memory location in which the working data and one or more random keys was stored by the packing module 27. The unpacking module 29 then determines, at S23, intermediate data corresponding to the or each random key by using the random key as a seed value for the deterministic function. The unpacking module then determines, at S25, a plurality of secret shares that satisfies the condition that a modulo addition of the determined plurality of secret shares corresponds to the modulo addition of the working data and the intermediate data corresponding to the or each random key.

It will be appreciated that given that the working data generated by the packing module 27 corresponds to the modulo addition of the values of a first plurality of secret shares and the inverse modulo addition of the intermediate data corresponding to the or each random key, the modulo addition of the plurality of secret shares generated by the unpacking module 29 is equal to the modulo addition of the first plurality of secret shares, and accordingly corresponds to the cryptographic key.

In the instance that d=2, an example of the processing operations of FIG. 3 can be represented by a function UnPackRefresh(S′, K) as follows:

Step 1. t=optional random data having n bits

### Step 2. S[1]=S′+t (mod q)

### Step 3. S[2]=f(K)−t (mod q)

Step 4. return (S[1], S[2])

In this example, in step 1 refresh data t is optionally generated from a uniform random distribution. The refresh data t has n bits, that is the same number of bits as each of the secret shares. Step 2 sets the first secret share to the modulo addition of the working data S′ and the refresh data t. Step 3 sets the second secret share to the inverse modulo addition of the intermediate data corresponding to the random key K and the refresh data t. In step 4, the first and second secret shares are returned.

By generating new refresh data t each time the function UnPackRefresh(S′,K) is executed, different sets of shares can be generated from the same compressed data. While this is an optional feature, and alternatively the refresh data could be either dispensed with or set to a fixed value in order to reduce the computational requirements, from a viewpoint of security generating new random refresh data each time the function UnPackRefresh(S′,K) is executed improves security against side channel attacks.

For the more general case where there is an arbitrary number d secret shares, an example of the processing operations of FIG. 2 can be represented by a function UnPackRefresh-Long(S′, K[1], K[2], . . . . K[d−1]) as follows:

Step 1. v=S′
Step 2.1. for i=1, 2, . . . d−1 do:

### Step 2.2. (v, S[i])=UnPackRefresh(v, K[i])

### Step 2.3. end do

### Step 3. S[d]=v

In step 1, the value of a working variable v is set to the value of the working data S′. Steps 2.1 to 2.3 iterate the UnPackRefresh algorithm discussed above with the working variable v and a random key K[i] as inputs to generated an updated value for the working variable v and a secret share S[i] corresponding to the random key K[i]. Finally, at step 3 the final secret share S[d] is assigned the value of the working variable v following completion of the iterations.

### Cryptographic Processing Module

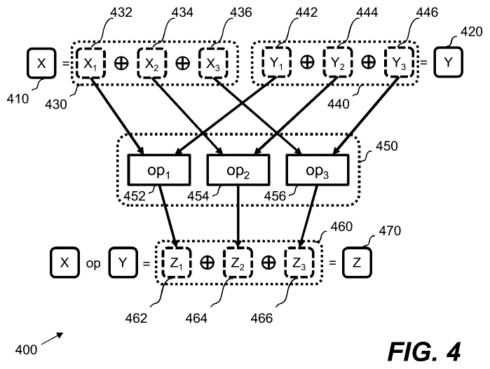

In masked cryptographic computation, arithmetic may be transformed into corresponding masked operations. For example, an unmasked (plain) arithmetic operation between variables X and Y, resulting in Z: Z=X op Y, may be transformed into a series of arithmetic operations from shares {Xᵢ} and {Yᵢ} to provide shares {Zᵢ}. This example is shown in FIG. 4.

FIG. 4 shows an operation 400 performed on two input data variables 410 and 420 (shown as X and Y). Each of the two input variables 410 and 420 are split into respective sets of data shares 430 and 440. In this example, there are three data shares, such that the first input variable 410 is split into data shares 432, 434 and 436 and the second input variable 420 is split into data shares 442, 444, and 446. Each of the data shares may comprise a sequence of bits of the same length as a sequence of bits representing the input variables. In the example of FIG. 4, the input variables are split into data shares using Boolean masking; however, different forms of masking may be available as a configurable or selectable control parameter. For example, there may be an option to generate data shares using either Boolean masking or arithmetic masking (amongst others). The cryptographic system may further be configured to convert between different forms of masking for certain operations.

The data shares can be used to perform an operation 450. The operation 450 is performed as a set of independent operations 452, 454 and 456 that each receive corresponding data shares from the two sets of data shares 430 and 440, e.g. operation 452 is performed with data shares 432 and 442 as input, operation 454 is performed with data shares 434 and 444 as input, and operation 456 is performed with data shares 436 and 446 as input. Each independent operation 452 to 456 is a repeat of the same arithmetic unit operation. Each of the masked arithmetic operations 452 to 456 (including conversions to masked form) is designed so that all intermediate variables are statistically independent of the (secret) sum of shares. The operations 452 to 456 are performed on the data shares of the secret but the data shares are not “collapsed” to reform the secret. Hence, the original secret is not “given away” to side-channel attacks.

In FIG. 4, after the operation 450 is performed on respective pairs of data shares, the result from each of the individual operations 452, 454 and 456 are provided as respective outputs 462, 464, and 466. The output set of data shares 460 may be recomposed to provide a result of the operation 450 as applied to the input variables 410 and 420 (i.e., Z=oper(X, Y)). In the example of FIG. 4, the recomposition may be performed by XOR summing the individual data shares, i.e. Z=Z₁⊕Z₂⊕Z₃. This may be performed as a last stage, e.g. when providing data as output via the set of bus interfaces 120 or following the completion of the operation 450, may be performed externally (e.g., by the external computing system), or even performed only when the data shares are encrypted as described below.

In certain implementations (and/or defined configurations), secret information may be maintained as data shares for an entire key lifecycle. For example, secret keys may be generated as shares, packed and stored in compressed format, and subsequently unpacked and loaded into memory as shares (e.g., both internal and external memory, the latter via the cryptographic registers 122), and used as shares (e.g., in cryptographic operations). At the end of the life of the key, the shares may then be zero-ed. In certain cases, only secret information is operated on as data shares. In these cases, if a set of data shares representing secret information are encrypted (e.g., using encryption and/or encapsulation algorithms implemented by the cryptographic system), they may be collapsed together following encryption, as the data is no longer “secret” (i.e., it is protected by the encryption). For example, a stream cipher may produce ciphertext C from plaintext P and keystream Z=cipher(key) via C=P XOR Z where decryption is performed as P=C XOR Z. In cases where the cipher is implemented in a masked fashion, the keystream shares Z₁, Z₂, Z₃ may be generated from masked keys—key₁, key₂, key₃. In this case different ciphertext portions may be encrypted using respective keystream shares C₁=P₁ XOR Z₁, C₂=P₂ XOR Z₂, and C₃=P₃ XOR Z₃. Following encryption, it is now possible to collapse the masks without giving away secret information, i.e. C=C₁ XOR C₂ XOR C₃. C can then be exported safely in an encrypted form that reveals no information about P.

Although the example of FIG. 4 shows a case of Boolean masking, in other examples, arithmetic masking may alternatively be used. In one case, arithmetic masking in the form of additive masking may be used to generate the data shares. Additive masking is analogous to XOR masking but uses integer or modular addition. In one case, the shares are computed as: X=(Σ_{d}Xᵢ) mod(q) where q may be an algorithm-dependent small prime or q=2ⁿ modulus. As an example, additive masking may be implemented by wrap-around addition modulus 2¹⁶. The fixed constant q may vary for different cryptographic algorithms. For many cryptographic algorithms, q is less than 16 or 32 bits in size or exactly a power of two. As examples, the KYBER algorithm uses a q value of 3329 and the SABER algorithm uses a value of 2¹³. Values of q for different cryptographic algorithms may be hardcoded into the implementation of the cryptographic math unit 130. As an example, the number X=1238 may be represented using shares X₁=1111, X₂=2222 and X₃=1234 with a q value of 3329, since X₁+X₂+X₃==4567 mod q=1238 (using modular wrap around addition).

In certain examples, the cryptographic system 110 may be arranged to perform operations that convert between two different masking formats. For example, linear operations such as XOR or addition may only be independently applied to data shares if the data shares are in a corresponding masking format. In one case, Boolean masking may be converted to and from arithmetic masking. In a case where Boolean masking is converted to arithmetic masking, this may be performed by determining a second set of data shares {Yᵢ} that have a sum that is equal to the XOR sum of a first set of data shares {Xᵢ}, e.g. S=⊕Xᵢ=ΣYᵢ. In a case where arithmetic masking is converted to Boolean masking, the reverse operation may be performed, e.g. a second set of data shares {Yᵢ} may be determined that have a sum that is equal to the arithmetic sum of a first set of data shares {Xᵢ}, e.g. S=ΣXᵢ=⊕Yᵢ. In certain cases, the control unit 150 may be programmed to use the arithmetic unit 136 and the matrix memory 132 to perform conversion operations in the hardware of the cryptographic system 110 that are similar to the conversion operations described in the paper “An Instruction Set Extension to Support Software-Based Masking” by Gao et al, Cryptology ePrint Archive, Report 2020/77, which is incorporated herein by reference. For example, the aforementioned paper defines BOOL2ARITH and ARITH2BOOL conversion functions that in turn utilise underlying Boolean add (BOOLADD) and Boolean substitution (BOOLSUB) operations. These Boolean add and Boolean substitution operations in turn comprise relatively complex sequences of bit manipulations involving a “mask random” input. The present cryptographic system 110 provides a large advantage over the software implementations of the paper (e.g., that are typically performed by a central processing unit of the external computing system), as the cryptographic math unit 130 is designed (and optimised) for accelerated execution of long sequences of Boolean operations (e.g., as demonstrated by the pipeline of FIG. 3). Hence, the cryptographic system 110 allows much faster operations.

Certain arithmetic primitives that are applied as operations by the arithmetic unit 136 may be accomplished with the help of conversion functions within a masked mode of operation (or the conversion functions may be implemented with the direct operations). For example, for Boolean masked addition and subtraction, a set of output data shares {Zᵢ} may be computed from input shares {Xᵢ} and {Yᵢ} such that the XOR sums satisfy X+Y=Z or X−Y=Z (mod q). Other masked functions may follow the same pattern. Bitwise logic in a masked mode may be performed by applying, say, AND, OR, and XOR operations to arithmetic-masked or Boolean-masked data shares. Likewise, shifts, rotations and bit manipulations may be applied to arithmetic-masked or Boolean-masked data shares. Comparisons may be performed by analysing equivalence or ordered (e.g., using less-than or greater-than) of masked variables. The results of comparisons may also be masked (e.g., a true or false value may be a masked bit). Field arithmetic and special functions for post-quantum cryptography may also be applied to masked variables.

Certain post-quantum cryptographic operations operate on ring polynomials. For example, lattice-based cryptography utilises ring polynomial and matrix multiplications. Many of these multiplications are between secret polynomials and public polynomials. In these cases, the secret polynomials may be masked, and the public polynomials need not be masked. In a case of multiplication of a secret polynomial X with a public polynomial C, the secret polynomial may be split into d data shares for a masked mode of operation, e.g. such that CX=CX₁+CX₂+CX₃ (mod q). In this case, multiplying by a constant (the public polynomial C) only causes an O(d) increase in complexity. This means that lattice-based post-quantum cryptography is particularly suited to a masked mode of operation. As a comparison, a multiplication of two masked representations, e.g. (X₁+X₂+X₃)*(Y₁+Y₂+Y₃), causes at least an O(d²) (i.e., quadratic) overhead in relation to the number of shares. Similarly, for many Number-Theoretic Transforms (NTT) that are used to implement ring and module algebraic objects used for known lattice cryptographic schemes, only one input of an NTT multiplication needs to be masked. This limits the overhead of applying a masking mode. Lattice cryptography additionally uses mixed bit-oriented operations such as right-shifts, “rounding,” and masked comparison. These tasks can be accomplished with more efficient partial masking conversion tailored for each operation.

Masking is applied in examples herein as a side-channel attack countermeasure. The cryptographic system 11 provides for hardware-accelerated cryptographic operations with integral hardware masking support. The masking may be configured to meet the requirements of the “non-invasive attack countermeasures” described in the FIPS 140-3 and ISO 19790 security standards, which are both incorporated by reference herein, (e.g., those defined in Section 7.8 of ISO/IEC 19790:2012(E)). Testing of the effectiveness of countermeasures such as masking as described herein may be performed using laboratory procedures such as those described in ISO/IEC 17825:2016(E) “Testing methods for the mitigation of non-invasive attack classes against cryptographic modules”, which is incorporated by reference herein, and more generally called Test Vector Leakage Assessment (TVLA).

In examples of the invention, the cryptographic processing module 35 perform data processing operations associated with one or both of the KYBER and the DILITHIUM post-quantum cryptographic algorithms.

### Modifications and Further Examples

With regard to the packing module 27 and the unpacking module 29, it will be appreciated that there are many variations of the described algorithms that could be used to achieve the same result. For example, the order of processing of pairs in PackRefresh-Long need not proceed sequentially with a single working variable, but could be computed in parallel if d is a power of two number such as 8 or 16 by using:

$$( {S}^{′} [ i ] , K [ i ] ) = PackRefresh ( S [ 2 * i - 1 ] , S [ 2 * i ] ) for I = \{ 1 , 2 , … d / 2 \}$$

A first iteration of such an arrangement produces d/2 random keys K[i] and d/2 shares S′[i]. The shares S′[i] are then processed in parallel to create d/4 random keys K[i] and d/4 shares S′[i] until a single share S′ remains, at which point d−1 random keys have been generated as in the sequential calculation.

The secret shares may be in various formats, for example in a vector format, a matrix format or a polynomial format. Accordingly, the intermediate data and the working data can also be in various formats to match that of the secret shares.

It will be appreciated that while the secret shares in the described examples correspond to a cryptographic key, secret share could represent other forms of secret data. For example, the secret shares could represent financial data such as a bank account number.

Although in the above examples the working data generated in the packing operation corresponds to a modulo addition of the values of the shares and an inverse modulo addition of the values of the intermediate data corresponding to each of the random keys while in the unpacking operation the plurality of secret shares correspond to a modulo addition of the working data and the intermediate data corresponding to each of the one or more random keys, in the alternative the packing operation can involve the modulo addition of the values of the shares and the values of the intermediate data corresponding to each of the random keys while in the unpacking operation the plurality of secret shares correspond to a modulo addition of the working data and an inverse modulo addition of the intermediate data corresponding to each of the one or more random keys.

Certain examples described herein provide a device (e.g., a cryptographic system or co-processor) that is able to perform post-quantum cryptography with masked arithmetic, i.e. data provided as masked data shares for side-channel protection. A masked mode of operation may utilise one or more of Boolean and arithmetic masking, and the device may provide for conversion between (at least these) different forms of masking. The described examples provide a novel cryptographic system structure or configuration that performs masking operations in a flexible and efficient manner to allow for both accelerated post-quantum cryptographic co-processing and high-security against side-channel attacks.

Certain examples described herein provide a device (e.g., a cryptographic system or co-processor) that is able to assist and/or accelerate cryptographic computations as well as perform certain full post-quantum cryptographic operations autonomously. For example, the device allows for public-key key establishment and encryption such as generation of a public-private key pair, encapsulation and/or encryption, and decapsulation and/or decryption. The device further allows digital signature functions such as generation of a public-private integrity key pair, signature generation and signature verification, as well as stateful hash-based signatures, such as assistance and/or acceleration of key generation, signature generation and/or signature verification functions. Such a device may be provided as a system-on-chip (e.g., integrated within a silicon design and/or provided as a separate FPGA/ASIC chip that may be attached).

Certain examples described herein provide a cryptographic system that is able to provide secure cryptographic computation. For example, one or more of the following post-quantum public-key encryption algorithms may be implemented: Classic McEliece, (CRYSTALS-) KYBER, NTRU, SABER, BIKE, FrodoKEM, HQC, NTRU Prime, SIKE, and Supersingular Isogeny Diffie-Hellman (SIDH); as well as one or more of the following post-quantum digital signature algorithms: (CRYSTALS-) DILITHIUM, FALCON, Rainbow, GeMSS, and Picnic. Further details of these algorithms may be found in available NIST publications for the “Post-Quantum Cryptography Project”, and publications for the CRYSTALS project—“Cryptographic Suite for Algebraic Lattices—Kyber and Dilithium”, which are incorporated by reference herein.

Certain examples described herein have a control unit that controls cryptographic operations without handling sensitive data (so-called “no-touch” operation). For example, the control unit may not have access to sensitive data in the cryptographic math unit during operation.

Certain examples further provide a method by which a control unit or processor may provide security tracking of secret data throughout cryptographic operations; hence, a control unit or processor may track the flow of sensitive information within the cryptographic system but without having access to that data.

The functions provided in the secure processing environment may be implemented in software, hardware or a combination of software of hardware. Accordingly, the packing module 27, the unpacking module 29 and cryptographic processing module 35 could be implemented as processor-implementable instructions which, when executed by a processor, perform their respective functions or a hardware circuit, for example an FPGA or an ASIC, which performs their respective functions, or a combination of processor-implementable instructions and hardware.

The above examples are to be understood as illustrative. Further examples are envisaged. Although certain components of each example have been separately described, it is to be understood that functionality described with reference to one example may be suitably implemented in another example, and that certain components may be omitted depending on the implementation. It is to be understood that any feature described in relation to any one example may be used alone, or in combination with other features described, and may also be used in combination with one or more features of any other of the examples, or any combination of any other of the examples. For example, features described with respect to the system components may also be adapted to be performed as part of the described methods. Furthermore, equivalents and modifications not described above may also be employed without departing from the scope of the invention, which is defined in the accompanying claims.

What is claimed is:

1. A computer-implemented method of storing data corresponding to secret data represented by a plurality of shares, each of the plurality of shares having a first number of bits, the method comprising:
generating one or more random keys, each random key having a second number of bits that is fewer than the first number of bits, wherein the one or more random keys comprises a number of random keys that is one fewer than the plurality of shares;
for each random key of the one or more random keys, using the generated random key as a seed value for a deterministic function that outputs corresponding intermediate data having the first number of bits;
performing a plurality of modulo addition operations to generate working data having the first number of bits and corresponding to modulo addition of the values of the shares and either a modulo addition or an inverse modulo addition of the values of the intermediate data corresponding to each of the random keys; and
storing the working data and the one or more random keys.

2. A computer-implemented method according to claim 1, wherein the performance of the modulo addition operations comprises performing the inverse modulo addition of at least one of the values of the intermediate data before performing all of the modulo additions of the values of the shares.

3. A computer-implemented method according to claim 1, wherein generating the working data comprises setting one of the plurality of shares as temporary data and for the rest of the plurality of shares, iteratively generating updated temporary data by performing a modulo addition of the value of the share the value of the temporary data and then performing an inverse modulo addition of respective intermediate data, wherein the updated temporary data is used as the temporary data for the next iteration and the updated temporary data after the final iteration forms the working data.

4. A computer-implemented method according to claim 1, wherein the number of the plurality of shares is a power of two, and wherein generating the working data comprises iteratively:
splitting the plurality of shares into pairs;
for each pair, generating first data by performing an inverse modulo addition of the value of one of the pair and the value of respective intermediate data, and generating second data by performing a modulo addition of the value of the other of the pair and the first data;
setting the second data generated for each pair as the plurality of shares for the next iteration;
wherein the second data of the final iteration forms the working data.

5. A computer-implemented method according to claim 1, wherein the method is performed within a secure processing environment.

6. A computer-implemented method according to claim 1, further comprising recovering the plurality of shares corresponding to the secret data from the working data and the one or more random keys, wherein each of the plurality of secret shares having a first number of bits and each of the one or more random keys having a second plurality of bits that is fewer than the first number of bits, and wherein the number of the one or more random keys is one fewer than the number of the plurality of secret shares,
the method comprising:
for the or each random key of the one or more random keys, determining intermediate data by using the random key as a seed value for a deterministic function that outputs corresponding intermediate data having the first number of bits;
determining the plurality of secret shares such that the modulo addition of the plurality of secret shares corresponds to either the modulo addition of the working data and the intermediate data corresponding to each of the one or more random keys or an inverse modulo addition of the working data and the intermediate data corresponding to each of the one or more random keys.

7. A computer-implemented method according to claim 6, wherein the plurality of secret shares consists of two secret shares and there is one random key, and wherein determining the two secret shares comprises:
generating random data having the first number of bits; and
performing a modulo addition of the working data and the random data to generate the first secret share; and
performing an inverse modulo addition of the intermediate data corresponding to the one random key and the random data.

8. A computer-implemented method according to claim 6, wherein the method comprises:
setting the value of a working variable to the value of the working data;
iteratively for each of the random keys:
generating random data having the first number of bits;
calculating a corresponding one of the remaining secret shares by performing an inverse modulo addition of the corresponding intermediate data and the random data; and
updating the working variable by performing a modulo addition of the working variable and the random data; and
following generation of the remaining secret shares, setting the one secret share to the value of the working variable.

9. An apparatus configured to perform masked processing operations using a plurality of shares corresponding to secret data, each of the plurality of shares having a first number of bits, the apparatus being configured to:
generate a plurality of random keys, each random key having a second number of bits that is fewer than the first number of bits, wherein the plurality of random keys is one fewer than the plurality of shares;
for each random key of the plurality of random keys, use the generated random key as a seed value for a deterministic function that outputs corresponding intermediate data having the first number of bits;
perform a plurality of modulo addition operations to generate working data having the first number of bits and corresponding to modulo addition of the values of the shares and either a modulo addition or an inverse modulo addition of the values of the intermediate data corresponding to each of the random keys; and
store the working data and the plurality of random keys.

10. An apparatus according to claim 9, wherein the performance of the modulo addition operations comprises performing the inverse modulo addition of at least one of the values of the intermediate data all of the modulo additions of the values of the shares have been performed.

11. An apparatus according to claim 9, wherein generating the working data comprises setting one of the plurality of shares as temporary data and for the rest of the plurality of shares, iteratively generating updated temporary data by performing a modulo addition of the value of the share the value of the temporary data and then performing an inverse modulo addition of respective intermediate data, wherein the updated temporary data is used as the temporary data for the next iteration and the updated temporary data after the final iteration forms the working data.

12. An apparatus according to claim 9, wherein the number of the plurality of shares is a power of two, and wherein generating the working data comprises iteratively:
splitting the plurality of shares into pairs;
for each pair, generating first data by performing an inverse modulo addition of the value of one of the pair and the value of respective intermediate data, and generating second data by performing a modulo addition of the value of the other of the pair and the first data;
setting the second data generated for each pair as the plurality of shares for the next iteration;
wherein the second data of the final iteration forms the working data.

13. An apparatus according to claim 9, wherein the apparatus provides a secure processing environment in which the masked processing operations take place.

14. An apparatus according to claim 9, wherein the apparatus is configured to perform masked processing operations implementing at least one of the KYBER cryptographic algorithm and the DILITHIUM cryptographic algorithm.

15. A computing system comprising an apparatus according to claim 9.

16. An apparatus configured to perform masked processing operations using a plurality of shares corresponding to secret data, each of the plurality of shares having a first number of bits, the apparatus being configured to recover a plurality of shares corresponding to secret data from stored working data and one or more random keys, wherein each of the plurality of secret shares having a first number of bits and each of the plurality of random keys having a second plurality of bits that is fewer than the first number of bits, and wherein the number of the one or more random keys is one fewer than the number of the plurality of secret shares, by
for the or each random key of the one or more random keys, determining intermediate data by using the random key as a seed value for a deterministic function that outputs corresponding intermediate data having the first number of bits;
determining the plurality of secret shares such that the modulo addition of the plurality of secret shares corresponds to either the modulo addition of the working data and the intermediate data corresponding to each of the one or more random keys or an inverse modulo addition of the working data and the intermediate data corresponding to each of the one or more random keys.

17. An apparatus according to claim 16, wherein the plurality of secret shares consists of two secret shares and there is one random key, and wherein determining the two secret shares comprises:
generating random data having the first number of bits; and
performing a modulo addition of the working data and the random data to generate the first secret share; and
performing an inverse modulo addition of the intermediate data corresponding to the one random key and the random data.

18. An apparatus according to claim 16, wherein the apparatus is configured to:
set the value of a working variable to the value of the working data;
iteratively for each of the random keys:
generate random data having the first number of bits;
calculate a corresponding one of the remaining secret shares by performing an inverse modulo addition of the corresponding intermediate data and the random data; and
update the working variable by performing a modulo addition of the working variable and the random data; and
following generation of the remaining secret shares, set the one secret share to the value of the working variable.

19. An apparatus according to claim 16, wherein the apparatus provides a secure processing environment in which the masked processing operations take place.

20. A computing system comprising an apparatus according to claim 16.
